(19) United States
(12) Patent Application Publication
(10) Pub. No.: US 2014/0149939 A1
(43) Pub. Date: May 29, 2014

(54) Apparatus And Method For Enabling Access To A Plurality of Activities

(71) Applicant: Kok Meng Michael Toh, Singapore (SG)

(72) Inventor: Kok Meng Michael Toh, Singapore (SG)

(21) Appl. No.: 14/110,177

(22) PCT Filed: Apr. 5, 2012
(86) PCT No.: PCT/SG2012/000122

§ 371 Date: Feb. 12, 2014

(30) Foreign Application Priority Data
Apr. 7, 2011 (SG) 201102544-2

(51) Int. Cl. G06F 3/0482; G06F 3/0481

(52) U.S. Cl. CPC G06F 3/0482; G06F 3/04817
USPC 715/835; 715/841

(57) ABSTRACT

There is provided an apparatus and a method for enabling access to a plurality of activities. The apparatus includes a processor for controlling the apparatus; and a communications module coupled to the processor for connecting the apparatus to a data network. The communications module may connect to the data network wirelessly. The plurality of activities may include, for example, consuming media content, carrying out e-shopping, playing video games, carrying out communications and so forth.

### FIELD OF INVENTION

This invention relates to an apparatus and a method for enabling access to a plurality of activities, the activities being accessible with use of a graphical user interface.

### BACKGROUND

It is now possible to access many different forms of activities from the comfort of any home. This is because of an increasing number of homes being connected to data networks in various manners, whereby the data networks include portals of activity providers that can be readily accessed by users at their homes which are connected to the data networks.

One example of how homes are connected to data networks is with the use of television “boxes” (also known as set-top boxes). These set-top boxes may be used for decoding scrambled television content signals for licensed subscribers and may also include a modem to connect the home to the Internet and/or other data networks. However, while these set-top boxes are able to connect the home to the Internet and/or other data networks, there are issues with regard to how to optimize the network connection for the users.

A significant problem relates to a restrictive nature of user interfaces running on these set-top boxes. The user interfaces of most of these set-top boxes are typically designed to be restrictive in a manner which enables a content provider(s) which provides such set-top boxes to increase their revenue by primarily marketing their own goods (content) and services.

As such, it is desirable if the user interfaces running on such set-top boxes were improved such that the user is able to optimize the network connection which is enabled from use of the set-top boxes.

### SUMMARY

In a first aspect, there is provided an apparatus for enabling access to a plurality of activities. The apparatus includes a processor for controlling the apparatus; and a communications module coupled to the processor for connecting the apparatus to a data network. The communications module may connect to the data network wirelessly. The plurality of activities may include, for example, consuming media content, carrying out e-shopping, playing video games, carrying out communications and so forth.

It is preferable that the processor is also configured to provide a graphical user interface which includes a first screen including a first selection row, where the first selection row denotes a plurality of selectable objects, with each of the plurality of selectable objects representing each of the plurality of activities, where selection of each of the plurality of selectable objects generates a second selection row.

The second selection row denotes a plurality of selectable sub-objects from a sub-category of a selected object from the first selection row; and a second screen subsequent to the first screen when a selected sub-object presents a list of items as the selected sub-object is not sub-categorised, the second screen including a first panel at the second screen denoting the list of items, a second panel at the second screen denoting details of an item selected from the list of items in the first panel. Advantageously, the graphical user interface is able to present information in a manner which leads a user towards a filtered selection of the plurality of activities.

The apparatus may be coupled to a display for showing the graphical user interface. The selectable objects, selectable sub-objects and items may be either text or graphical icons. The second selection row may be narrower than the first selection row.

The second panel may include at least one control for the selected item. The first panel and the second panel may be adjacent to one another. The first panel may include at least one sub-panel.

In a second aspect, there is provided a method for enabling access to a plurality of activities using an apparatus including a processor for controlling the apparatus; and a communications module coupled to the processor for connecting the apparatus to a data network. The apparatus may be coupled to a display for showing the graphical user interface. The plurality of activities may include, for example, consuming media content, carrying out e-shopping, playing video games, carrying out communications and so forth.

Preferably, the method is enabled by the processor which is also configured to provide a graphical user interface, the method including choosing a selectable object from a first selection row on a first screen, where the first selection row denotes a plurality of the selectable objects, with each of the plurality of selectable objects representing each of the plurality of activities, where selection of each of the plurality of selectable objects generates a second selection row; choosing a selectable sub-object from the second selection row on the first screen, where the second selection row denotes a plurality of the selectable sub-objects from a sub-category of the selectable object from the first selection row; and choosing from a list of items on a second screen subsequent to the first screen, the second screen being generated when the selected sub-object presents the list of the items as the selected sub-object is not sub-categorised, the second screen including a first panel at the second screen denoting the list of items, a second panel at the second screen denoting details of an item selected from the list of items in the first panel.

It is advantageous that the graphical user interface is able to present information in a manner which leads a user to a filtered selection of the plurality of activities.

The selectable objects, selectable sub-objects and items may be either text or graphical icons. The second selection row may be narrower than the first selection row.

The second panel may include at least one control for the chosen item. The first panel and the second panel may be adjacent to one another. The first panel may include at least one sub-panel.

### DESCRIPTION OF FIGURES

In order that the invention may be fully understood and readily put into practical effect, the invention shall now be described by way of non-limitative example only exemplary embodiments, the description being with reference to the accompanying illustrative figures.

FIG. 1 shows a first screen of a graphical user interface of a preferred embodiment of the present invention.

FIG. 2 shows a first example of a second screen of the graphical user interface of the preferred embodiment of the present invention.

FIG. 3 shows a second example of a second screen of the graphical user interface of the preferred embodiment of the present invention.

FIG. 4 shows a third example of a second screen of the graphical user interface of the preferred embodiment of the present invention.

FIG. 5 shows a schematic diagram of an apparatus of the preferred embodiment of the present invention.

FIG. 6 is a process flow of a method of the preferred embodiment of the present invention.

FIG. 7 shows a fourth example of a second screen of the graphical user interface of the preferred embodiment of the present invention.

### DESCRIPTION OF PREFERRED EMBODIMENTS

The preferred embodiments of the invention will be described with reference to the various provided figures. An appearance of the figures is purely illustrative and not limiting in any manner.

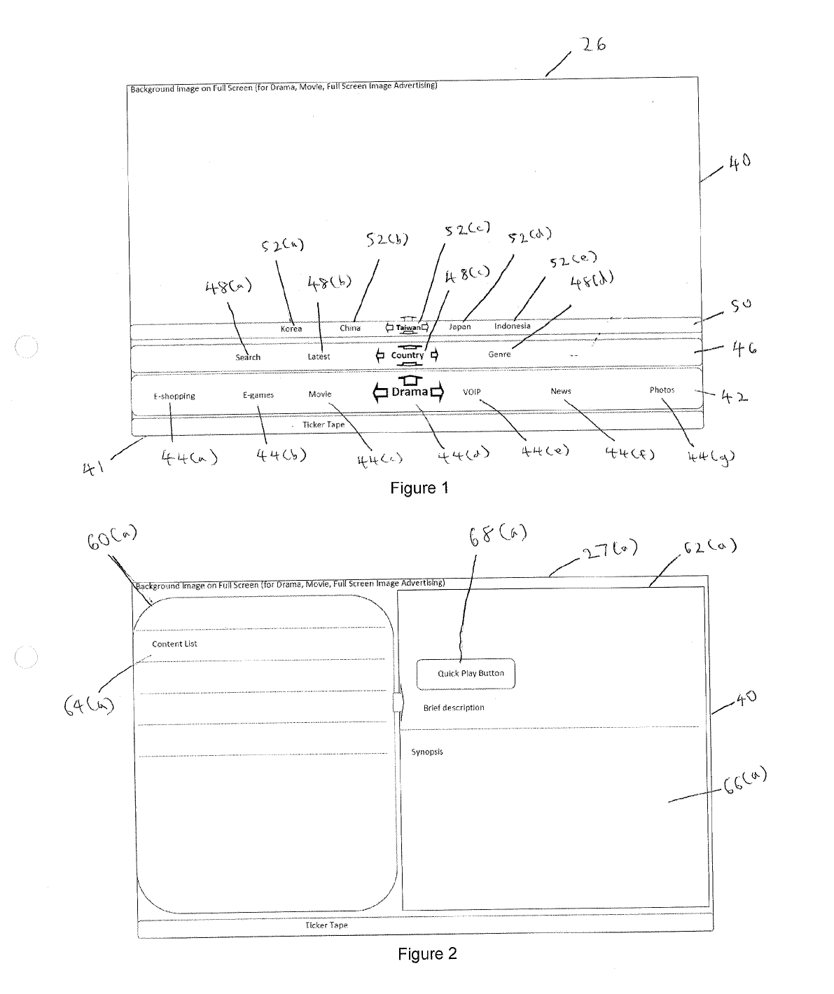

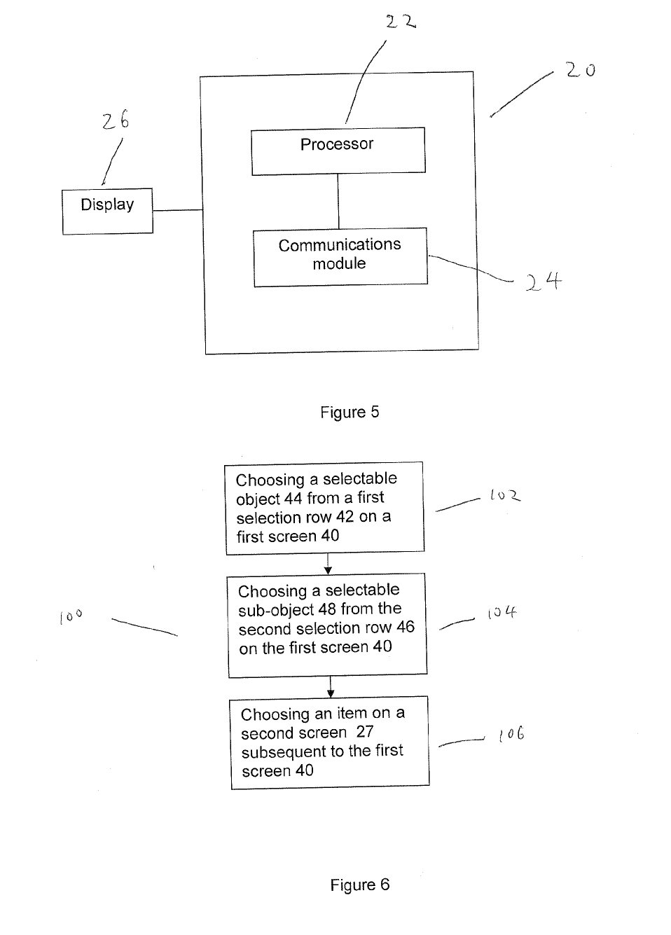

Referring to FIG. 5, there is provided a schematic diagram for an apparatus 20 for enabling access to a plurality of activities. The apparatus 20 includes a processor 22 for controlling the apparatus 20; and a communications module 24 coupled to the processor 22 for connecting the apparatus 20 to a data network. The communications module 24 may connect to the data network wirelessly. The plurality of activities includes, for instance, consuming media content, carrying out e-shopping, playing video games, carrying out communications and so forth. The plurality of activities is able to be accessed as the processor 22 is also configured to provide a graphical user interface shown in FIGS. 1-4. The apparatus 20 is coupled to a display 26 for showing the graphical user interface. The display 26 may be either a separate viewing monitor or incorporated within the apparatus 20.

Referring to FIG. 1, there is shown a first screen 40 on the display 26 including a first selection row 42, where the first selection row 42 denotes a plurality of selectable objects 44(a), 44(b), 44(c), 44(d), 44(e), 44(f), 44(g). Selection of each of the plurality of selectable objects 44(a), 44(b), 44(c), 44(d), 44(e), 44(f), 44(g) generates a second selection row 46, where the second selection row 46 denotes a plurality of selectable sub-objects 48(a), 48(b), 48(c), 48(d), 48(e) from a sub-category of a selected object from the first selection row 42. The selectable objects 44(a), 44(b), 44(c), 44(d), 44(e), 44(f), 44(g), and selectable sub-objects 48(a), 48(b), 48(c), 48(d), 48(e) are represented by either text (as shown) or graphical icons.

In FIG. 1, it should be noted that the selectable objects 44(a), 44(b), 44(c), 44(d), 44(e), 44(f), 44(g) are for the various activities that the user is able to access. For instance, the user is able to carry out e-shopping by selecting “e-shopping” 44(a), the user is able to play video games by selecting “e-games” 44(b), the user is able to consume media content by selecting “movie” 44(c)/“drama” 44(d)/“news” 44(f)/“photos” 44(g), the user is able to carry out communications by selecting “VOIP” 44(e), and so forth.

For the sake of illustration, when the user selects “drama” 44(d) (as denoted by outward arrows around “drama” 44(d)), the selectable sub-objects “search” 48(a), “latest” 48(b), “country” 48(c), “genre” 48(d) associated with the selectable object “drama” 44(d) are shown in the second selection row 46. It should be noted that the second selection row 46 only appears after “drama” 44(d) is selected.

Furthermore, when the selectable sub-object “country” 48(c) is selected (as denoted by outward arrows around “country” 48(c)), a third selection row 50 then appears, the third selection row 50 showing selectable sub-sub-objects “Korea” 52(a), “China” 52(b), “Taiwan” 52(c), “Japan” 52(d), “Indonesia” 52(e) associated with the selectable sub-object “country” 48(c).

It should be noted that the second selection row 46 is narrower compared to the first selection row 42, while the third selection row 50 is narrower compared to the second selection row 46. The narrowing of successive selection rows 42, 46, 50 aids in providing the user with a perception of depth (or filtering) in relation to accessing a desired activity using the apparatus 20. While it is illustrated that there are three selection rows 42, 46, 50 in the first screen 40, there may possibly be more or less than three selection rows 42, 46, 50 in the first screen 40, depending on individual activities available for selection. Furthermore, while the selection rows 42, 46, 50 are shown to be located towards a lower edge 41 of the first screen 40, it should be noted that the selection rows 42, 46, 50 may be located towards other edges of the first screen 40 and need not be in a length-wise orientation as shown in FIG. 1.

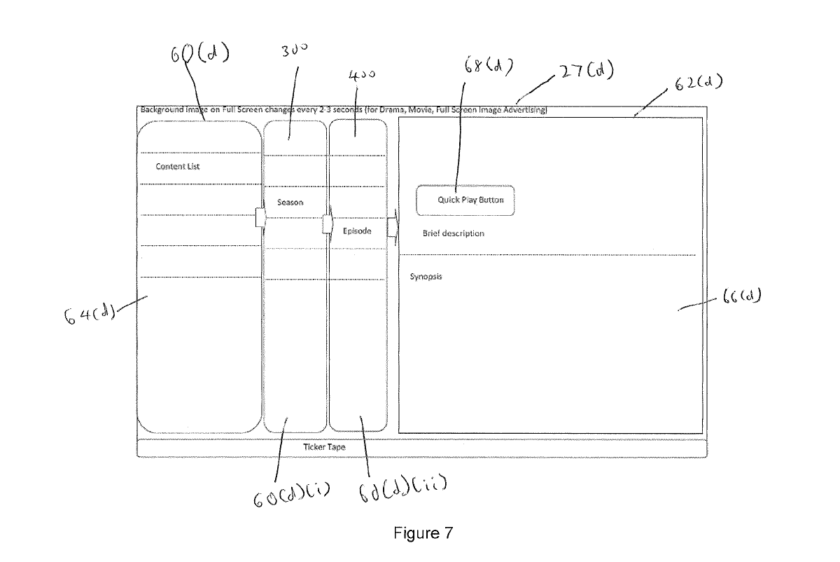

Referring to FIGS. 2-4, and 7 there are shown examples of a second screen 27(a), 27(b), 27(c), 27(d) which are presented subsequent to the first screen 26 when a selected sub-object does not have any further sub-categorisations. The second screen 27 presents a list of items 64(a), 64(b), 64(c), 64(d) for selection in a first panel 60(a), 60(b), 60(c), 60(d) at the second screen 27(a), 27(b), 27(c), 27(d). A second panel 62(a), 62(b), 62(c), 62(d) at the second screen 27(a), 27(b), 27(c), 27(d) may be for denoting details 66(a), 66(b), 66(c), 66(d) of an item selected from the list of items 64(a), 64(b), 64(c), 64(d) in the first panel 60(a), 60(b), 60(c), 60(d). The second panel 62(a), 62(b), 62(c), 62(d) may include controls 68(a), 68(b), 68(c), 68(d) for an element selected from the list of items 64(a), 64(b), 64(c), 64(d) in the first panel 60(a), 60(b), 60(c), 60(d). This will be described in greater detail in subsequent paragraphs. In addition, the first panel 60(a), 60(b), 60(c) and the second panel 62(a), 62(b), 62(c) of the second screen 27(a), 27(b), 27(c) are adjacent to one another. In FIG. 7, the first panel 60(d) and the second panel 62(d) are not adjacent to one another.

FIG. 2 shows a first example of the second screen 27(a). The first example of the second screen 27(a) may be generated when any one of “e-games” 44(b), “movie” 44(c), “drama” 44(d), “news” 44(f), “photos” 44(g) from the first selection row 42 is selected. The list of items 64(a) shown in the first panel 60(a) include, for example, movie titles, video game titles, drama serial titles, newspaper titles, magazine titles, photo tags, and the like. Each element on the list of items 64(a) is represented by either text or a graphical icon. The second panel 62(a) may be for denoting details 66(a) of each element on the list of items 64(a) either when the user scrolls through individual elements in the list of items 64(a) or when the user selects an element from the list of items 64(a). The details 66(a) may be, for example, a summary, a synopsis, a description, a thumbnail image, and so forth. The control 68(a) in the second panel 62(a) may be a “quick play” control as shown which enables immediate access to the selected element from the list of items 64(a). It should be noted that there may be more than one control 68(a) in the second panel 62(a) with different functions, such as, for example, a “resume content” control, an “episode selector” control and so forth.

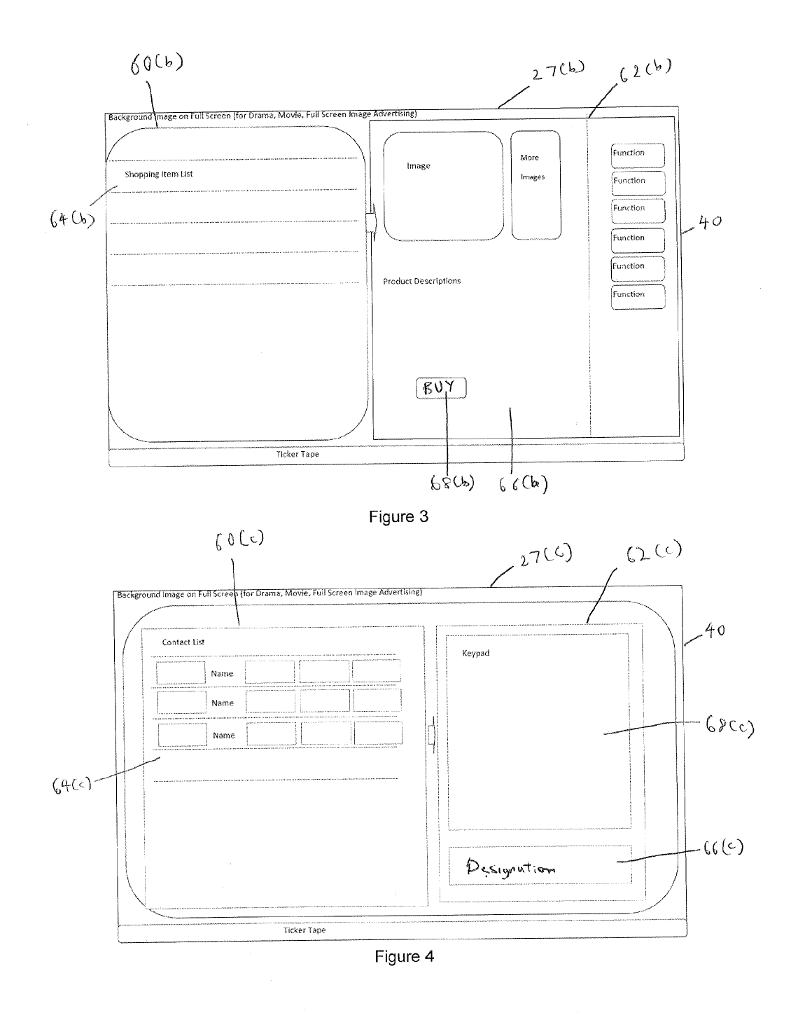

FIG. 3 shows a second example of the second screen 27(b). The second example of the second screen 27(b) may be generated when “e-shopping” 44(a) from the first selection row 42 is selected. The list of items 64(b) shown in the first panel 60(b) may include products/services able to be purchased remotely by the user. Each element on the list of items 64(b) is represented by either text or a graphical icon. The second panel 62(b) may be for denoting details 66(b) of each element on the list of items 64(b) either when the user scrolls through individual elements in the list of items 64(b) or when the user selects an element from the list of items 64(b). The details 66(b) may be, for example, a product/service description, images of product/service and so forth. The control 68(b) in the second panel 62(b) may be a “buy” control as shown which enables immediate purchase of the selected element from the list of items 64(b). It should be noted that there may be more than one control 68(b) in the second panel 62(b) with different functions, such as, for example, a “related product/service” control, a “change retailer” control and so forth.

FIG. 4 shows a third example of the second screen 27(c). The third example of the second screen 27(c) may be generated when “VOIP” 44(e) from the first selection row 42 is selected. The list of items 64(c) shown in the first panel 60(c) may be a contact list. Each element on the list of items 64(c) is represented by either text or a graphical icon. The second panel 62(c) may be for denoting details 66(c) of each element on the list of items 64(c) either when the user scrolls through individual elements in the list of items 64(c) or when the user selects an element from the list of items 64(c). The details 66(c) may be, for example, a contact's designation, a contact's employer and so forth. The control 68(c) in the second panel 62(c) may be a keypad control for inputting a number(s) for the selected element from the list of items 64(c). It should be noted that there may be more than one control 68(c) in the second panel 62(c) with different functions, such as, for example, a “connect to URL” control, a “send an email” control and so forth.

FIG. 7 shows a fourth example of the second screen 27(d). The fourth example of the second screen 27(d) may be generated when “drama” 44(d) is selected. The fourth example of the second screen 27(d) is similar to the first example of the second screen 27(a) as the fourth example also denotes displaying media content. The list of items 64(d) shown in the first panel 60(d) include primarily drama serial titles. Each element on the list of items 64(d) is represented by either text or a graphical icon. Drama serial titles typically are sub-categorized into seasons where each season includes a grouping of episodes. As such, the fourth example includes a sub-first panel 60(d)(i) for showing a seasons list 300 available for a particular drama serial, and also includes a sub-sub-first panel 60(d)(ii) for showing an episodes list 400 available for a particular season. It should be noted that the sub-first panel 60(d)(i) is visually narrower than the sub-sub-first panel 60(d)(ii) as this aids in providing the user with a perception of depth (or filtering).

The second panel 62(d) may be for denoting details 66(d) of an episode shown in the sub-sub-first panel 60(d)(ii) either when the user scrolls through the episodes list 400 or when the user selects an element from the episodes list 400. The details 66(d) may be, for example, a summary, a synopsis, a description, a thumbnail image, and so forth. The control 68(d) in the second panel 62(a) may be a “quick play” control as shown which enables immediate access to the selected element from the episodes list 400. It should be noted that there may be more than one control 68(d) in the second panel 62(d) with different functions, such as, for example, a “resume content” control, a “parental restriction” control and so forth.

It should be appreciated that the user who uses the apparatus 20 for enabling access to a plurality of activities is able to do so in an intuitive and convenient manner. The user would be guided in a non-confusing manner during use of the apparatus 20 towards the desired activity with use of only the first screen 26 and the second screen 27(a), 27(b), 27(c). There is clearly no need for the user to navigate through numerous screens which is tedious and sometimes confusing. It is advantageous that the graphical user interface is able to present information in a manner which leads a user towards a filtered selection of the plurality of activities.

Referring to FIG. 6, there is shown a process flow for a preferred embodiment for a method 100 for enabling access to a plurality of activities using an apparatus 20 as described in the preceding paragraphs. References to FIGS. 1-5, and 7 will also be made where possible. The apparatus 20 includes a processor 22 for controlling the apparatus 20; and a communications module 24 coupled to the processor 22 for connecting the apparatus 20 to a data network. The communications module 24 may connect to the data network wirelessly. The plurality of activities includes, for instance, consuming media content, carrying out e-shopping, playing video games, carrying out communications and so forth. The plurality of activities is able to be accessed as the processor 22 is also configured to provide a graphical user interface shown in FIGS. 1-4, and 7. The apparatus 20 is coupled to a display 26 for showing the graphical user interface. The display 26 may be either a separate viewing monitor or incorporated within the apparatus 20.

The method 100 includes choosing a selectable object 44 from a first selection row 42 on a first screen 40 (102). The first selection row 42 denotes a plurality of selectable objects 44(a), 44(b), 44(c), 44(d), 44(e), 44(f), 44(g). Selection of each of the plurality of selectable objects 44(a), 44(b), 44(c), 44(d), 44(e), 44(f), 44(g) generates a second selection row 46, where the second selection row 46 denotes a plurality of selectable sub-objects 48(a), 48(b), 48(c), 48(d), 48(e) from a sub-category of a selected object from the first selection row 42. The selectable objects 44(a), 44(b), 44(c), 44(d), 44(e), 44(f), 44(g), and selectable sub-objects 48(a), 48(b), 48(c), 48(d), 48(e) are represented by either text (as shown) or graphical icons.

It should be noted that the second selection row 46 is narrower compared to the first selection row 42, while the third selection row 50 is narrower compared to the second selection row 46. The narrowing of successive selection rows 42, 46, 50 aids in providing the user with a perception of depth (or filtering) in relation to accessing a desired activity using the apparatus 20. While it is illustrated that there are three selection rows 42, 46, 50 in the first screen 40, there may possibly be more or less than three selection rows 42, 46, 50 in the first screen 40, depending on individual activities available for selection. Furthermore, while the selection rows 42, 46, 50 are shown to be located towards a lower edge 41 of the first screen 40, it should be noted that the selection rows 42, 46, 50 may be located towards other edges of the first screen 40 and need not be in a length-wise orientation as shown in FIG. 1.

The method 100 then includes choosing a selectable sub-object 48 from the second selection row 46 on the first screen 40 (104). Finally, the method 100 includes choosing from a list of items on a second screen 27 subsequent to the first screen 40 (106), the second screen 27 being generated when the selected sub-object presents the list of the items as the selected sub-object is not sub-categorised, the second screen 27 including a first panel 60 at the second screen 27 denoting the list of items 64, a second panel 62 at the second screen 27 denoting details of an item selected from the list of items 64 in the first panel 60.

Referring to FIGS. 2-4, and 7, there are shown examples of a second screen 27(a), 27(b), 27(c), 27(d) which are presented subsequent to the first screen 26 when a selected sub-object does not have any further sub-categorisations. The second screen 27 presents a list of items 64(a), 64(b), 64(c), 64(d) for selection in a first panel 60(a), 60(b), 60(c), 60(d) at the second screen 27(a), 27(b), 27(c), 27(d). A second panel 62(a), 62(b), 62(c), 62(d) at the second screen 27(a), 27(b), 27(c) may be for denoting details 66(a), 66(b), 66(c) of an item selected from the list of items 64(a), 64(b), 64(c) in the first panel 60(a), 60(b), 60(c). Alternatively, the second panel 62(a) may be for denoting details 66(d) of an element selected from the episode list 400 in the sub-sub-first panel 60(d)(ii).

The second panel 62(a), 62(b), 62(c) may include controls 68(a), 68(b), 68(c) for an element selected from the list of items 64(a), 64(b), 64(c) in the first panel 60(a), 60(b), 60(c). Alternatively, the second panel 62(d) may include a control 68(d) for an element selected from the episodes list 400 in the sub-sub-first panel 60(d)(ii). In addition, the first panel 60(a), 60(b), 60(c) and the second panel 62(a), 62(b), 62(c) of the second screen 27(a), 27(b), 27(c) are adjacent to one another.

It should be appreciated that the user who uses the method 100 while using the apparatus 20 for enabling access to a plurality of activities is able to do so in an intuitive and convenient manner. The user would be guided in a non-confusing manner during the method 100 towards the desired activity with use of only the first screen 26 and the second screen 27(a), 27(b), 27(c). There is clearly no need for the user to navigate through numerous screens, which is tedious and sometimes confusing. It is advantageous that the graphical user interface is able to present information in a manner which leads a user towards a filtered selection of the plurality of activities.

Whilst the foregoing description has described exemplary embodiments, it will be understood by those skilled in the technology concerned that many variations in details of design, construction and/or operation may be made without departing from the present invention.

1. An apparatus for enabling access to a plurality of activities, the apparatus including:
a processor for controlling the apparatus; and
a communications module coupled to the processor for connecting the apparatus to a data network;
wherein the processor is also configured to provide a graphical user interface which includes:
a first screen including a first selection row, where the first selection row denotes a plurality of selectable objects, with each of the plurality of selectable objects representing each of the plurality of activities, where selection of each of the plurality of selectable objects generates a second selection row, where the second selection row denotes a plurality of selectable sub-objects from a sub-category of a selected object from the first selection row; and
a second screen subsequent to the first screen when a selected sub-object presents a list of items as the selected sub-object is not sub-categorised, the second screen including a first panel at the second screen denoting the list of items, a second panel at the second screen denoting details of an item selected from the list of items in the first panel,
the graphical user interface being able to present information in a manner which leads a user towards a filtered selection of the plurality of activities.

2. The apparatus of claim 1, wherein the apparatus is coupled to a display for showing the graphical user interface.

3. The apparatus of claim 1, wherein the selectable objects, selectable sub-objects and items are either text or graphical icons.

4. The apparatus of claim 1, wherein the second selection row is narrower than the first selection row.

5. The apparatus of claim 1, wherein the second panel includes at least one control for the selected item.

6. The apparatus of claim 1, wherein the first panel and the second panel are adjacent to one another.

7. The apparatus of claim 1, wherein the plurality of activities is selected from a group comprising: consuming media content, carrying out e-shopping, playing video games, and carrying out communications.

8. The apparatus of claim 1, wherein the communications module connects to the data network wirelessly.

9. The apparatus of claim 1, wherein the first panel includes at least one sub-panel.

10. A method for enabling access to a plurality of activities using an apparatus including:
a processor for controlling the apparatus; and
a communications module coupled to the processor for connecting the apparatus to a data network;
wherein the method is enabled by the processor which is also configured to provide a graphical user interface, the method including:
choosing a selectable object from a first selection row on a first screen, where the first selection row denotes a plurality of the selectable objects, with each of the plurality of selectable objects representing each of the plurality of activities, where selection of each of the plurality of selectable objects generates a second selection row;
choosing a selectable sub-object from the second selection row on the first screen, where the second selection row denotes a plurality of the selectable sub-objects from a sub-category of the selectable object from the first selection row; and
choosing from a list of items on a second screen subsequent to the first screen, the second screen being generated when the selected sub-object presents the list of the items as the selected sub-object is not sub-categorised, the second screen including a first panel at the second screen denoting the list of items, a second panel at the second screen denoting details of an item selected from the list of items in the first panel,
the graphical user interface being able to present information in a manner which leads a user to a filtered selection of the plurality of activities.

11. The method of claim 10, wherein the apparatus is coupled to a display for showing the graphical user interface.

12. The method of claim 10, wherein the selectable objects, selectable sub-objects and items are either text or graphical icons.

13. The method of claim 10, wherein the second selection row is narrower than the first selection row.

14. The method of claim 10, wherein the second panel includes at least one control for the chosen item.

15. The method of claim 10, wherein the first panel and the second panel are adjacent to one another.

16. The method of claim 10, wherein the plurality of activities is selected from a group comprising: consuming media content, carrying out e-shopping, playing video games, and carrying out communications.

17. The method of claim 10, wherein the first panel includes at least one sub-panel.
